(19) United States
(12) Patent Application Publication
(10) Pub. No.: US 2021/0279757 A1
(43) Pub. Date: Sep. 9, 2021

(54) Customized Credit Card Welcome Offers Based on Transactional Data

(71) Applicant: The Toronto-Dominion Bank, Toronto (CA)

(72) Inventors: Kimberley Jane Medel, Mississauga (CA); Neha Dipna Kalwani, Toronto (CA)

(73) Assignee: The Toronto-Dominion Bank, Toronto (CA)

(21) Appl. No.: 16/807,745

(22) Filed: Mar. 3, 2020

(51) Int. Cl. G06Q 30/02

(52) U.S. Cl. CPC G06Q 30/0224

(57) ABSTRACT

The present disclosure involves, systems, software, and computer-implemented methods for providing a personalized welcome offer to a customer based on the customer's transactional data. One example computer system comprises a memory storing instructions; a communications interface; and at least one hardware processor interoperably coupled with the memory and the communications interface, wherein the instructions instruct the at least one hardware processor to: identify a user from a database; generate a personalized welcome offer for the user including an offer to open an account and a personalized welcome bonus associated with the opening of the account; pre-approve the user for the personalized welcome offer; provide the personalized welcome offer to a device of the user via the communications interface; receive acceptance of the personalized welcome offer via the communications interface; and generate a data record associated with the account and initiate effects of the personalized welcome bonus upon opening the account.

### BACKGROUND

Credit cards and debits cards are popular methods of providing payment for financial transactions. Debit cards are typically tied to a person's bank account, and during a transaction using a debit card, money is immediately transferred from the cardholder's bank account. Credit cards allow a customer to make a purchase based on the cardholder's promise to pay back the credit company, sometimes in addition to other agreed upon charges. Some credit card companies offer rewards to their customers to incentivize the customers to use a particular company's credit card rather than another form of payment, such as cash, check, or other credit card. The rewards may be in the form of points or cash paid back to the customer, as well as other rewards.

### SUMMARY

The present disclosure involves systems, software, and computer-implemented methods for providing a personalized welcome offer to a customer based on the customer's transactional data. Many bank customers are not enrolled in credit cards or other payment instruments that would provide the customers with benefits that they would not otherwise receive, such as accelerator points for purchases. Frequently, these customers are using cash, debit cards that provide very few purchase benefits, and/or credit cards that do not provide the customers with the appropriate benefits or rewards for their spending. For example, a significant portion of a customer's spending may be on groceries, but debit cards and/or credit cards that the customer uses do not provide any benefits or rewards for grocery purchases made using the card(s). This customer would instead benefit from using a credit card or other payment instrument that provides benefits or rewards for grocery purchases. However, many customers are unware of the credit cards or other payment instruments that would provide better benefits/rewards or find it too difficult to switch to a new credit card or other payment account, such as a debit card or mobile payment account that offers rewards on purchases.

The disclosed technical solution provides a tool that selects a credit card product for a customer and generates a personalized welcome offer for the customer based on the customer's transactional data (e.g., spending patterns). The personalized welcome offer leverages pre-existing relationships with merchants to offer the customer accelerators with merchants that are frequented by the customer and with which the bank has pre-existing relationships. In order to enhance customer experience, the tool may pre-approve the customer for the credit card and, upon approval from the customer, may open the customer's new account in real-time. Additionally, the tool may provide, in real-time, the credit card information to electronic payment tools (e.g., electronic wallet) used by the customer. Once open, the promotional welcome offer can be applied to incoming purchases, such that any benefits associated with the offer are immediately realized. These steps allow the customer to immediately and easily gain access to the benefits of the new credit card.

An example computing device comprises: a memory storing instructions, a communications interface, and at least one hardware processor interoperably coupled with the memory and the communications interface, wherein the instructions instruct the at least one hardware processor to: identify, from a database of users associated with an institution, a first user; generate a personalized welcome offer for the first user, the personalized welcome offer comprising an offer to open a new account and a personalized welcome bonus associated with the opening of the new account; based on identifying the first user, pre-approve the first user for the personalized welcome offer; based on a successful pre-approval, provide the personalized welcome offer to a device associated with the first user via the communications interface; receive acceptance of the personalized welcome offer from the device associated with the first user via the communications interface; and in response to receiving acceptance of the personalized welcome offer, generate a new data record associated with the new account for the first user and initiate effects of the personalized welcome bonus upon opening the new account.

In some implementations, the instructions further instruct the at least one hardware processor to provide information relating to the new account to one or more electronic payment tools installed on the device associated with the first user. In some implementations, the institution is a financial institution. In some implementations, the new account is a financial instrument account.

In some implementations, the financial instrument account includes a credit card account. In some implementations, the financial instrument account includes a mobile payment instrument account.

In some implementations, the first user is selected based on one or more of the first user's spending patterns, current financial instruments offered by the financial institution, and one or more financial instruments that the first user is currently using. In some implementations, the first user is identified as being eligible for a new offer for a financial instrument

In some implementations, the instructions further instruct the at least one hardware processor to generate the welcome bonus, including select one or more entities, wherein the welcome bonus includes one or more accelerators associated with entities that are anchor tenants of the institution and whose services or products the first user purchases. In some implementations, selection of entities is based on a determination of the anchor tenants of the institution and an analysis of enterprise data of the first user.

In some implementations, the analysis determines the entities at which the first user makes frequent purchases. In some implementations, the analysis determines the entities at which the first user has made purchases that exceed a total threshold purchase amount.

In some implementations, the welcome bonus includes one or more elements, including a length of the personalized welcome offer, an accelerator bonus, and a number of entities. In some implementations, the elements of the welcome bonus are based on an analysis of enterprise data including time of year, spending patterns of the first user, eligible merchants for the offer, demographics of the first user, and data associated with comparable users.

In some implementations, the personalized welcome offer is provided through directed advertising via authorized social media or mail.

In some implementations, the instructions further instruct the at least one hardware processor to provide the device associated with the first user with one or more incentives to use one or more rewards accumulated from the personalized welcome bonus after a predetermined time has elapsed since opening the new account.

In some implementations, the instructions further instruct the at least one hardware processor to provide a notification to the device associated with the first user indicating a number of points earned for a particular transaction using the new account.

In some implementations, the instructions further instruct the at least one hardware processor to identify a transaction that involves the new account of the first user, determine that the transaction is associated with an accelerator of the personalized welcome bonus, and apply the accelerator to the transaction.

The technical solutions described herein provide a number of benefits to financial institutions and their customers. Implementing the technical solutions described herein, financial institutions can proactively (e.g., in real-time) communicate with their customers various offers about which the customer may not have otherwise been knowledgeable. Moreover, by generating offers based on the customer's transactional data and spending patterns, financial institutions can provide financial tools that best suit the needs of customers, thereby increasing the number of customers of those financial institutions and also decreasing attrition. By providing such targeted offers, customers and potential customers may find financial tools and methods of payment that best serve them and their spending patterns, resulting in the greatest number of benefits (e.g., rewards or cashback). Still further, the financial institution and merchants associated with the promotional welcome offer can benefit from new, and more loyal, customers, who may further interact with the merchants based on the updated card benefits.

Previously, customers who used only debit cards earned no or very little rewards for using their debit cards in transactions. Consequently, these customers missed out on opportunities to earn benefits or cashback for transactions that they would have otherwise earned. Implementations described herein would increase customers' ability to earn rewards and benefits for purchases made using credit cards with the financial institutions.

Alternatively, the present solution may be used for non-credit-based cards, as well as alternative payment instruments and/or cards, including debit cards, phone and mobile payment accounts, prepaid cards, digital wallets, cryptocurrency accounts, or the like.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a conceptual diagram of a system for providing a personalized welcome offer to a customer based on the customer's transactional data.

FIG. 2 is a sequence diagram depicting an example of steps for providing a customized offer to a customer.

FIG. 3 is a schematic diagram depicting an identification of a user and generating of a personalized welcome offer using the system and methods described herein.

FIG. 4 is a diagram depicting an example use case using the systems and methods described herein.

FIG. 5 shows an example of a computer device and a mobile computer device that can be used to implement the techniques described here.

### DETAILED DESCRIPTION

In general, this document describes mechanisms for providing a personalized welcome offer to a customer based on the customer's transactional data. In some instances, debit cardholders can use their debit cards to make financial transactions, but generally do not benefit from many, if any, rewards from use of the debit cards. For example, a debit cardholder has the benefit of using the debit card to facilitate transactions (e.g., in person or online), but use of the debit card does not typically result in accumulating rewards points, and debit cards do not typically afford added benefits for use at specific merchants.

Presented herein are tools and methods for providing a user with a personalized welcome offer for a financial instrument, where the personalized welcome offer is generated based on the particular user's transaction data. In particular, a tool is provided that selects or otherwise identifies a customer who is eligible for a new financial instrument offer. This selection may be based on enterprise data, such as the customer's spending patterns (e.g., top spending categories), current financial instruments offered by a particular financial institution (e.g., bank), and the product or products that the customer currently uses (e.g., debit cards). Other relevant information, such as that corresponding to cohorts or other similarly-situated customers similar to the selected customer, can also be used to identify those who may benefit from a particular offer.

After the customer is selected, the tool generates a personalized welcome offer for the customer. The personalized offer includes a particular financial instrument and a personalized welcome bonus. The personalized welcome bonus may include accelerators at one or more merchants, such as those that are anchor tenants of the financial institution and/or whose products or services the customer frequently purchases. Selection of the merchants may be based on a determination of the anchor tenants of the bank and/or an analysis of enterprise data of the customer. The analysis may determine the merchants at which the customer makes frequent purchases and/or at which the customer makes purchases that exceed a total threshold purchase amount.

The personalized welcome bonus may include various elements. Such elements include, for example, a length of the offer, an accelerator bonus, and a number of or particular set of merchants. These elements may be based on an analysis of enterprise data, including the time of the year, the spending patterns of the customer, the eligible merchants for the offer, the demographics of the customer, and data associated with other comparable customers, among others.

After the customer welcome offer is generated for the customer, the tool may pre-approve the customer for the offer. The tool may further provide the offer to the customer, for example, through directed advertising via authorized social media or mail. When a customer agrees to the offer, the tool may open the customer's new financial instrument account in real-time. Additionally, the tool may, in real-time, provide financial instrument account information associated with the new account to electronic payment tools (e.g., electronic wallet) used by the customer, as well as those maintained by the particular merchants associated with the offer.

Once the time period of the personalized welcome bonus is over, the tool may provide the customer with incentives to quickly use the rewards accumulated from the welcome bonus.

The implementations described herein provide a number of benefits. For example, financial institutions can proactively incentivize existing customers to use additional financial products or services offered by the financial institutions. The implementations described herein can further provide customers of the financial institutions with financial products and services that best suit their spending patterns and allow the user to accumulate the greatest number of benefits, for example, through spending rewards programs. Additionally, engagement in rewards programs can be increased by providing knowledge of the value of reward points and rewards program, thereby also decreasing attrition.

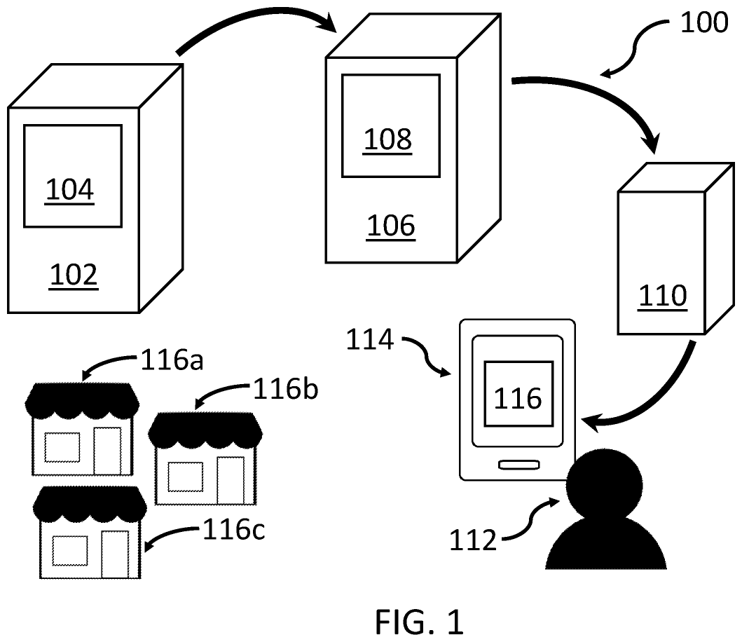

Turning to the illustrated example implementation, FIG. 1 shows a conceptual diagram of a system 100 for providing a personalized welcome offer to a customer based on the customer's transactional data.

The system 100 includes an enterprise data provisioning platform 102, an offer management system 106, and a fulfillment engine 110. The customer's transaction data is held in a data repository on the enterprise data provisioning platform 102. In particular, the enterprise data provisioning platform 102 includes a database 104 of financial institution customer data. In some implementations, the database 104 can be securely accessed by other financial institution systems or engines. Customer transaction data may include, for example, historical and current transaction data (e.g., from customer accounts). This customer transaction data may show, or allow to be derived, patterns of customer behavior. Additionally, external data from one or more data sources may be used to enrich the historical and current transaction data included in the database 104, including data sources managed by the financial institution, as well as other private and/or public third party data sources. Additional demographic information may be included in the database, such as information about a population of people living, working, or moving around, through or near a particular location. Information about those persons may include income information, commuting patterns, population density at different times, and other information. Additionally, weather data can enrich the historical and current transaction data.

Offer management system 106 includes an offer decision engine 108. The offer decision engine 108 selects a customer 112 for a new offer. Selection of the customer 112 may be based on identifying the customer 112 as being eligible for a new offer for a financial instrument. The selection may be based on data analysis of customer data to determine spending patterns, available financial instrument products offered by the financial institution, and/or current financial products used by the customer 112, such as debit cards or credit cards.

The offer decision engine 108 additionally generates a personalized welcome offer for the selected customer 112. The personalized welcome offer includes a financial instrument offered by the financial institution. This financial instrument may be selected based on, for example, data analysis of customer data to determine spending patterns. The financial instrument may be, for example, a credit card or mobile payment instrument, as well as a new or alternative debit card. For example, if a customer makes frequent travel-related expenses, a travel credit card may be selected for the customer that offers benefits (e.g., bonus rewards points) for travel-related purchases. In another example, if a customer frequently incurs restaurant-related expenses, a credit card may be selected for the customer that offers benefits (e.g., bonus rewards points) for restaurant-related purchases.

The personalized welcome offer further includes a personalized welcome bonus. The personalized welcome bonus includes various information, including merchants at which the customer 112 will receive accelerator points (i.e., rewards points earned at a faster rate).

Selection of the merchants at which the customer 112 will receive accelerator points may be based on a determination of anchor tenants of the financial institution and data analysis of customer data to determine spending patterns. The anchor tenants may include, for example, third party merchants with whom the financial institution has a preexisting relationship.

For example, the financial institution may have a preexisting relationship with an airline company such that the airline company is an anchor tenant of the financial institution, such as one that provides a preferred credit card branded by the anchor tenant. Analysis of the customer data may show that the customer frequently makes purchases with the airline company. Alternatively, analysis of the customer data may show that the customer has spent more than a threshold amount of money (e.g., $2,500) with the airline company during a predetermined period (e.g., the last year). As a result of the analysis, the personalized welcome bonus may include the airline company as a merchant at which the customer 112 earns rewards points at a faster than normal rate of earning.

The personalized welcome bonus includes an accelerator offer, which includes various elements. These elements may include, for example, the length of the offer, the accelerator amount, and the number of or identification of merchants. The elements of the accelerator offer may be based on data analysis of customer data to determine spending patterns, the time of year, the eligible merchants for the offer, the demographics of the customer 112, and data associated with other comparable customers.

For example, the customer may be provided with a personalized welcome offer that allows the customer to earn points on purchases with an airline company. The personalized welcome offer further includes a personalized welcome bonus that allows the customer to earn these points at a higher rate of earning (e.g., 50 points per dollar spent versus 10 points per dollar spent) during an introductory period (e.g., the first three months after activation of the card). In some instances, the personalized welcome offer allows the customer to earn accelerated points at more than one merchant. For example, the personalized welcome offer for a customer who is determined to spend more than a threshold amount on travel-related purchases may earn accelerated points at both an airline company and at a hotel chain.

In some instances, the offer decision engine 108 of the offer management system 106 may analyze the demographics of the customer 112 and data associated with other customers having similar demographics. For example, the offer decision engine 108 may analyze the customer's information to determine that he is a white male between the ages of 35-49 that resides in New York City. Analysis of data associated with other customers having similar demographics may show that other white males between the ages of 35-49 who reside in New York City frequently make purchases with rideshare companies. As a result of this analysis, the offer decision engine 108 may determine whether the financial institution has a preexisting relationship with one or more rideshare companies and include the one or more rideshare companies as merchants for the offer.

The system 100 also includes a fulfillment engine 110 that preapproves the customer 112 for the customer welcome offer and provides the customer 112 with the personalized welcome offer. The fulfillment engine 110 may provide the customer 112 with the personalized welcome offer via, for example, authorized social media, electronic mail, or mail (e.g., USPS). The fulfillment engine 110 also opens new customer accounts in real-time, following customer approval, and provides financial instrument information for the new customer account to electronic payment tools and/or customer accounts associated with selected merchants for the offers (e.g., accounts for online shopping platforms, gas stations, restaurants). The new customer accounts may be opened, for example, via an adjudication process and/or account creation process.

Additionally, the system 100 includes a customer 112 using a mobile computing device 114. The mobile computing device 114 includes a mobile application 116 associated with the financial institution installed on the device. After a new financial instrument account is created for the customer 112, the mobile application 116 may be used to provide the financial instrument information to electronic payment tools and customer accounts associated with selected merchants for the offers through the merchant's mobile applications. The customer 112 may use the mobile computing device 114 to receive communications from the financial institution. For example, the customer 112 may receive the personalized welcome offer from the fulfillment engine 110, and the customer 112 may further confirm acceptance of the personalized welcome offer to the fulfillment engine 110 using the mobile computing device 114. A physical payment card issued to the user in association with the new financial instrument account may also be generated and distributed.

The mobile computing device 114 may optionally include one or more other applications by which the customer 112 may be provided with notifications that the customer 112 has been preapproved for a personalized welcome offer for a new financial instrument account. For example, the mobile computing device 114 may include a social media application which may provide for display and interaction a communication that informs the customer that he has been preapproved for a credit card account, where the preapproval is associated with a welcome offer that is personalized to the particular customer.

The customer 112 may frequent one or more merchants 116a-c, as evidenced by enterprise data in the bank customer data database 104. The merchants may include, for example, retail merchants, restaurants, coffee shops, gas stations, convenience stores, airlines, hotels, cab services, online ride-share applications, cellular service providers, wireless service providers, cable service providers, music services, and mobile application providers.

In some instances, after a predetermined time has elapsed since opening the new account or since the personalized welcome offer has been accepted, the fulfillment engine 110 may provide a notification to the customer 112 indicating the number of points that the customer 112 has earned for one or more transactions using his new financial instrument account. Such a notification has the benefit of informing the customer 112 of the value of the financial instrument, as well as enticing the customer 112 to continue to use the financial instrument to continue to earn points. In some instances, the notification may also provide information regarding the remaining period in the welcome bonus period, if the time period is limited.

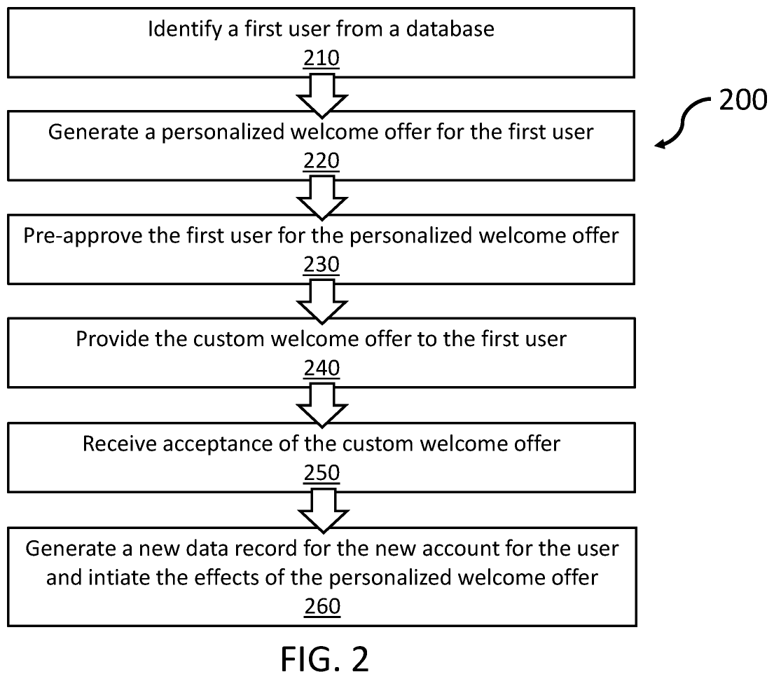

FIG. 2 is a sequence diagram depicting an example of steps 200 for providing a personalized welcome offer to a customer based on the customer's transactional data. At step 210, a first user is identified from a database of users for a personalized welcome offer. The users may be, for example, customers of an institution. For example, the database of users may be a repository of a customer data for a financial institution (e.g., a bank) that can be accessed by other financial institution systems or engines. The database may store various type of information relating to customers, as described above with respect to FIG. 1.

The first user may be selected for the personalized welcome offer based on, for example, data analysis of customer data, available financial instruments (e.g., credit cards, mobile payment instruments, etc.) offered by the financial institution, and current financial instruments used by the customer. Customer data may be analyzed to determine spending patterns of the users. In some instances, a consideration of the potential welcome offers may be triggered based on a customer action, such as logging into the financial institution's website or opening a related application. In other instances, the consideration/analysis may be performed at a predetermined period, in response to financial institution-wide triggers for a plurality of users, or based on any suitable trigger, period, or event.

At step 220, a personalized welcome offer is generated for the first user. The personalized welcome offer includes an offer to open a new account and a personalized welcome bonus associated with the opening of the account. In some instances, the new account is a financial instrument account. In some instances, the financial instrument is a credit card. In other instances, the financial instrument is a mobile payment instrument.

In some instances, generating the personalized welcome offer includes generating a personalized welcome bonus, including selecting one or more entities. The personalized welcome bonus may include one or more accelerators associated with entities that are anchor tenants of the financial institution and whose services or products the first user purchases. Selection of the entities may be based on a determination of the anchor tenants of the financial institution and an analysis of enterprise data of the first user. In some instances, the analysis of enterprise data includes determining the entities at which the first user makes frequent purchases. In some instances, the analysis determines the entities at which the first user has made purchases that exceed a total threshold purchase amount. The first user's purchase total may be limited to a predetermined time period.

In some instances, the welcome bonus includes one or more elements. These elements may include a length of the personalized welcome offer, an accelerator bonus, and a number of entities. The elements of the personalized welcome bonus may be based on an analysis of enterprise data, including a time of year, spending patterns of the first user, eligible merchants for the offer, demographics of the first user, and data associated with comparable users.

At step 230, the first user is preapproved for the personalized welcome offer. Preapproval of the first user may be based on one or more of the first user's payment history, credit score, monthly minimum debt payments, balances on other financial instrument(s), age, and/or income. The preapproval may also take into account whether the first user has any fraud alerts on any financial instrument accounts, any history of delinquent payments, current balances on credit cards or loans, and whether the first user has recently applied for other financial instruments.

At step 240, a computing device associated with the first user is provided with the personalized welcome offer. In some instances, the device of the first user is provided with the personalized welcome offer based on and/or in response to a successful pre-approval. The device of the first user may be provided with the personalized welcome offer via any number of methods of communication. For example, the device of the first user may be provided with the personalized welcome offer via an e-mail message, a text message, a web page associated with the financial institution, an application (e.g., mobile application) associated with the financial institution, mail, or a telephone call. In some instances, the offer may be actively provided to the device of the first user (e.g., via a direct communication, such as through a communication sent to the device of the first user through any direct channel), while in others, the offer may be passive (e.g., provided as personalized advertising in a website or social network, or provided only after the first user requests such an offer).

At step 250, an indication of acceptance of the personalized welcome offer is received from the device of the first user. The user may accept the personalized welcome offer using the same method of communication by which the offer was provided to the user. For example, the acceptance may comprise the first user sending an e-mail to the financial institution, accepting the offer via text message, accepting the offer via a web page associated with the financial institution, accepting the offer by clicking a link in a web page or in an e-mail, accepting the offer using a mobile application associated with the financial institution, accepting the offer by mail, verbally communicating acceptance, or the like.

At step 260, a new data record associated with the new account for the user is generated in response to receiving the indication of acceptance from the first user. The effects and terms of the personalized welcome bonus are initiated upon opening the new account. In some instances, after the new data record is generated for the new account, information relating to the new financial instrument account (e.g., account number, expiration date, card verification value (CVV) code, etc.) is provided to one or more electronic payment tools associated with the first user. For example, the device of the first user may have installed or running on it one or more electronic payment tools that the first user can use to complete financial transactions. By providing the information relating to the new financial instrument account to one or more electronic payment tools on the device of the first user, the first user can then use the new financial instrument to make future purchases and earn rewards according to the first user's personalized welcome offer using his or her computing device. Any suitable disclosures and terms can also be provided to the first user for approval, as required. Any bonus points associated with the offer can be deposited into a loyalty account of the first user, and any future earnings can be calculated based on the bonus rates, where applicable.

In some instances, after a predetermined time has elapsed since opening the new account, the first user may be provided with one or more incentives to use rewards accumulated from use of the account. The rewards may be accumulated from use of the new account with the personalized welcome bonus.

In some instances, the first user may be provided with one or more notifications that provide a quantitative value that indicates the amount of rewards accumulated by using the new financial instrument account. For example, the first user may periodically receive notifications that include the user's rewards points balance for the new financial instrument account.

In some instances, after the account has been opened, a transaction that involves the use of the first user's financial instrument may be identified. The transaction may be determined to be associated with an accelerator associated with the personalized welcome bonus, and as a result, the accelerator is applied to the transaction so that the first user enjoys the benefits of the personalized welcome bonus.

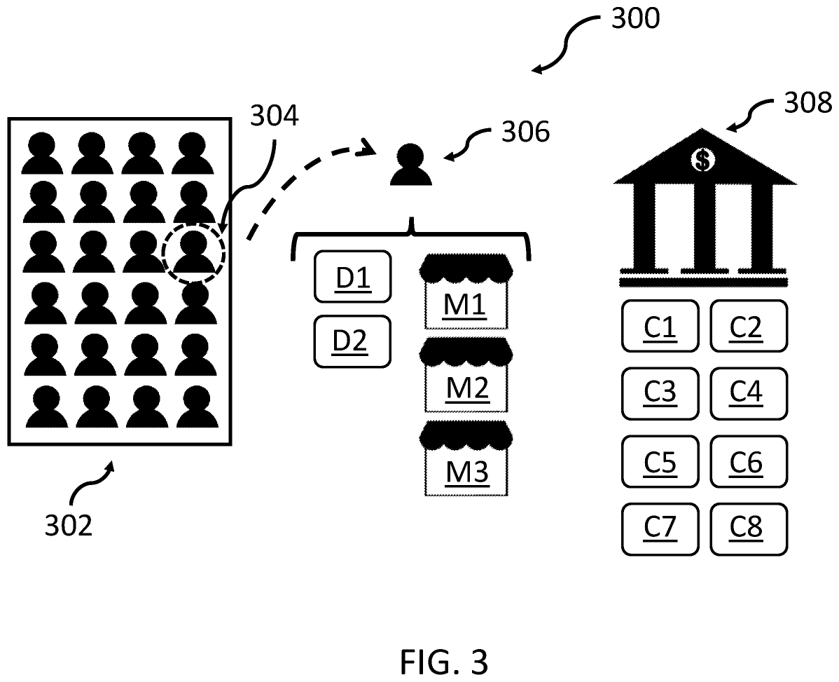

FIG. 3 is a schematic diagram 300 depicting an identification of a user and generating of a personalized welcome offer as described herein. In particular, a database of customers 302 is provided for selecting a user for whom to provide a personalized welcome offer. The customers may be, for example, current customers of a financial institution 308. More particularly, the customers may be current customers of the financial institution 308 who have debit card accounts with the financial institution 308 but who do not have other accounts, such as credit card accounts, with the financial institution 308.

A tool is provided that selects a particular user who is eligible for a financial instrument account offer. Selection of the user may be based on various information. For example, the selection may be based on enterprise data, including the customer's spending patterns (e.g., top spending categories), current credit cards or other financial instruments offered by the financial institution 308, and current financial instruments or products that a customer is currently using (e.g., debit cards).

In one example, the tool may analyze the spending patterns of each of the users in the database 302 and identify one or more customers who frequently make purchases in a particular category, such as travel. The tool may further determine that the one or more customers are using financial instruments to make these travel-related purchases that do not provide rewards points for the spending. For example, the one or more customers may be using one or more debit cards to make the travel-related purchases, where the debit cards do not offer any awards for travel-related spending. The tool may further identify that the financial institution 308 is currently offering one or more financial instruments that provide rewards for travel-related purchases.

As shown in FIG. 3, a particular user 306 maybe selected from the database 302, where the selection is indicated by a circle 304. The tool analyzes the database 302 and associated enterprise data to determine that the particular selected user 306 has various financial instrument accounts D1, D2 and is associated with a number of merchants M1-M3. The financial instrument accounts D1, D2 may be, for example, debit card accounts for which the user does not earn any or many rewards points. The financial instrument accounts D1, D2 may be accounts associated with the financial institution 308 that is currently offering personalized welcome offers, but it is not limited as such.

The merchants M1-M3 are entities from whom the user 306 makes frequent purchases. For example, M1 may be a specific airline from whom the user 306 makes frequent purchases. M2 may be a hotel or hotel chain with whom the user 306 frequently stays. M3 may be a mobile application, such as a rideshare application, that the user 306 frequently uses and makes frequent payments. Alternatively, merchants M1-M3 may simply represent broader categories of purchases that the customer frequently makes. For example, M1 may represent travel-related purchases, M2 may represent restaurant-related purchases, and M3 may represent gas station purchases.

The merchants M1-M3 may be entities with whom the user 306 has had more than a threshold number of transactions over a predetermined time period. Alternatively, the merchants M1-M3 may be entities with whom the user 306 has spent over a threshold amount of money over a predetermined period. Ultimately, identification of the merchants M1-M3 allow the tool to identify information about the spending patterns of the user 306 to determine potential financial instruments from which the user 306 may benefit. Identification of the merchants M1-M3 can further allow the tool to select a particular financial instrument to offer, as described below.

The tool further analyzes enterprise data that includes the financial products that the financial institution 308 is currently offering. As shown in FIG. 3, the financial institution 308 is offering financial instruments C1-C8. The financial instruments C1-C8 may be, for example, various credit cards. Additionally or alternatively, one or more of the financial instruments C1-C8 may be mobile payment instruments or the like. Each of the financial instruments C1-C8 may be associated with different types of benefits. For example, C1 may offer specialized travel-related bonuses, while C2 may offer bonuses related to purchases restaurants and C3 may offer bonuses related to purchases at gas stations. In some instances, one or more of the financial instruments C1-C8 may be associated with a particular merchant or merchants that has or have a relationship with the financial institution 308. These financial instruments may be co-branded with the particular merchant or merchants. In particular, one or more of the financial instruments may be associated with anchor tenants of the financial institution 308 (e.g., merchants with whom the financial institution 308 has a prior relationship).

In an example, the tool identifies user 306 for a personalized welcome offer. The tool identifies that the user 306 currently has two accounts with the financial institution 308, debit card D1 and debit card D2. The tool further identifies from the user's spending patterns that the user makes frequent purchases from merchants M1-M3. M1 is ABC Airlines, M2 is a DEF Hotel Chain, and M3 is GHI Car Rental Services.

Based on this information, the tool analyzes financial instruments C1-C8 that the financial institution 308 is currently offering. The tool determines that financial instruments C2 and C7 are associated with travel-related bonuses. C2 may be, for example, a credit card that is co-branded between the financial institution 308 and a particular anchor tenant of the financial institution 308. For example, the anchor tenant may be ABC Airlines, and credit card C2 may allow customers to earn points that can be used at ABC Airlines. C2 may typically allow customers to earn 20 points per dollar spent at ABC Airlines and 1 point per dollar spent at other merchants. Credit card C2 may allow customers to earn bonus points purchasing from ABC Airlines rather than other merchants. C7 may be, for example, a travel rewards credit card that allows customers to earn rewards on all travel-related purchases, regardless of the particular merchant. C7 may typically allow customers to earn 10 points per dollar spent on all travel-related purchases and 2 dollars on all non-travel related purchases.

The tool may additionally identify spending amounts of the user 306 associated with the various merchants. For example, the tool may determine that, in the last year, the user 306 spent $10,000 at ABC Airlines, $1,500 at DEF Hotel Chain, and $250 at GHI Car Rental Services. In this scenario, the tool may determine that the user 306 would be more likely to benefit from co-branded credit card C2 because the user 306 had made a majority of his purchases at ABC Airlines, with whom the credit card C2 is co-branded. In particular, if the user 306 had used credit card C2 on his purchases at ABC Airlines, DEF Hotel Chain, and GHI Car Rental services, the user 306 would have earned 200,000 points from his purchases with ABC Airlines, 1,500 points from his purchases with DEF Hotel Chain, and 250 points from his purchases with GHI Car Rental Services for a total of 201,550 points. If the user 306 had instead used credit card C7 on these purchases, he would have earned 100,000 from his purchases with ABC Airlines, 3,000 from his purchases with DEF Hotel Chain, and 500 points from his purchases with GHI Car Rental Services for a total of only 103,500. Thus, given the user's spending patterns of the last year, the user 306 would be more likely to benefit from credit card C2.

Alternatively, the tool may determine that, in the last year, the user spent $10,000 at ABC Airlines, $15,000 at DEF Hotel Chain, and $9,000 at GHI Car Rental Services. In this scenario, the tool may determine that because the user 306 has spent a more uniform amount among ABC Airlines, DEF Hotel Chain, and GHI Car Rental Services, the user 306 may instead derive greater benefits from credit card C7 that offers bonus points earning for all travel-related purchases. In particular, if the user 306 had used credit card C7 on his purchases at ABC Airlines, DEF Hotel Chain, and GHI Car Rental services, the user 306 would have earned 100,000 points from his purchases with ABC Airlines, 150,000 points from his purchases with DEF Hotel Chain, and 90,000 points from his purchases with GHI Car Rental Services for a total of 340,000 points. If the user 306 had instead used credit card C2 on these purchases, he would have earned 200,000 from his purchases with ABC Airlines, 15,000 from his purchases with DEF Hotel Chain, and 9,000 points from his purchases with GHI Car Rental Services for a total of only 234,000. Thus, given the user's spending patterns of the last year, the user 306 would be more likely to benefit from credit card C7.

While in these examples, the tool analyzes the user's spending pattern over the last year, this time period can be any other predetermined or predefined time period (e.g., 2 years, 6 months, 3 months, 30 days).

After a user 306 is selected from the database 302, the tool generates a personalized welcome offer for the user 306, including a personalized welcome bonus. For example, the tool may determine, as explained in the example above, that based on the enterprise data relating to the user 306 and the financial instruments C1-C8 currently offered by the financial institution 308 that the user 306 would likely derive the greatest benefit from financial instrument C7, which offers bonus points for travel-related purchases.

In addition to the standard bonus earning associated with financial instrument C7, the tool generates a personalized welcome bonus for the user 306. In some instances, the personalized welcome offer and the personalized welcome bonus are generated to leverage preexisting relationships that the financial institution 308 has with merchants to offer the user 306 accelerators with merchants that are frequented by the user 306 and with which the financial institution 308 has a preexisting relationship.

Returning to the example above, the tool determines that over the last year, the user 306 spent $10,000 at ABC Airlines, $1,500 at DEF Hotel Chain, and $250 at GHI Car Rental Services and would thus be more likely to benefit from credit card C2. The standard benefits of credit card C2 would allow the user 306 to earn 20 points per dollar on all purchases with ABC Airlines and 1 point per dollar on all other purchases. Based on preexisting relationships between the financial institution 308 and ABC Airlines, the tool may determine that the financial institution 308 can offer the user 306 an accelerator of 60 points per dollar on all purchases with ABC Airlines for the first six months after activation of the credit card C2 (or for the first six months after the first transaction using credit card C2). After the six month period has elapsed, the user 306 would revert to the standard benefits of 20 points per dollar spent with ABC Airlines and 1 point per dollar spent on all other purchases.

Returning to the alternative example above, the tool determines that over the last year, the user 306 spent $10,000 at ABC Airlines, $15,000 at DEF Hotel Chain, and $9,000 at GHI Car Rental Services and would thus be most likely to benefit from credit card C7. The standard benefits of credit card C7 would allow the user 306 to earn 10 points per dollar on all travel-related purchases, including purchases with ABC Airlines, DEF Hotel Chain, and GHI Car Rental Services. The standard benefits of credit card C7 would further allow the user 306 to earn 2 points per dollar on all non-travel-related purchases. The tool may then determine whether accelerators can be provided in a personalized welcome offer for the user 306 that allow the user 306 to earn even more bonus points during a predetermined welcome period. For example, the tool may determine that preexisting relationships between the financial institution 308 and travel-related merchants would permit the financial institution to offer the user 306 accelerators of 50 points on all travel-related purchases and 5 points for all non-travel-related purchases during the first three months after activation of the credit card (or for the first three months after the first transaction using credit card C7). After the three month period has elapsed, the user 306 would revert to the standard benefits of 10 points per dollar spent on travel and 2 points per dollar spent on all other purchases.

The particular length of the offer may vary and may be based, for example, on the preexisting relationship(s) between the financial institution 308 and one or more merchants. The length of the offer and other elements of the personalized welcome bonus, such the accelerator bonus, the number of merchants associated with the personalized bonus, and the types of purchases associated with the personalized bonus, may be based on an analysis of enterprise data. Analysis of enterprise data may include analysis of the time of the year, the spending patterns of the customer, the eligible merchants for the offer, the demographic of the customer, and data associated with other comparable customers.

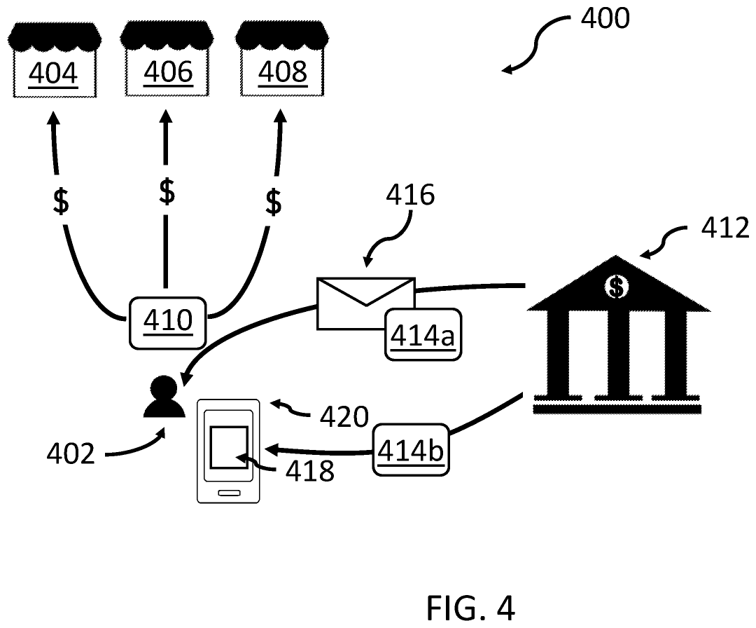

An example use case in illustrated in the system shown in FIG. 4. In this example a customer 402 uses a rideshare service 404 to commute, purchases coffee from a chain café 406 on a daily basis, and frequently purchases items from an international e-commerce website 408. All of the customer's purchases are made with a debit card 410 associated with a financial institution 412. Based on data analytics, as generally described above, the customer 402 is presented with a pre-approved credit card offer including a personalized welcome offer 414a, 414b from the financial institution 412. The customer 402 may be presented with notification of the pre-approval and offer via any number of communication methods.

For example, the financial institution 412 may send the customer 402 the personalized welcome offer 414a by way of mail 416 directly to the user. Alternatively or additionally, one or more computing systems associated with the financial institution 412 (not shown) may send the personalized welcome offer 414b to the customer 402 electronically to a computing device 420 associated with the customer 402. For example, the one or more computing systems associated with the financial institution 412 may send the personalized welcome offer 414b to the customer 402 using an application running on the user's device 420. In this manner, the one or more computing systems can notify the user of the personalized welcome offer 414b via social media advertising or through directed e-mail, for example.

The personalized welcome offer 414a, 414b includes accelerators for the ride-share service 404, the chain café 406, and the e-commerce company 408. For example, the personalized welcome offer 414a, 414b includes 5× the points at these select merchants 404, 406, 408 for the first three months after the first transaction using the credit card.

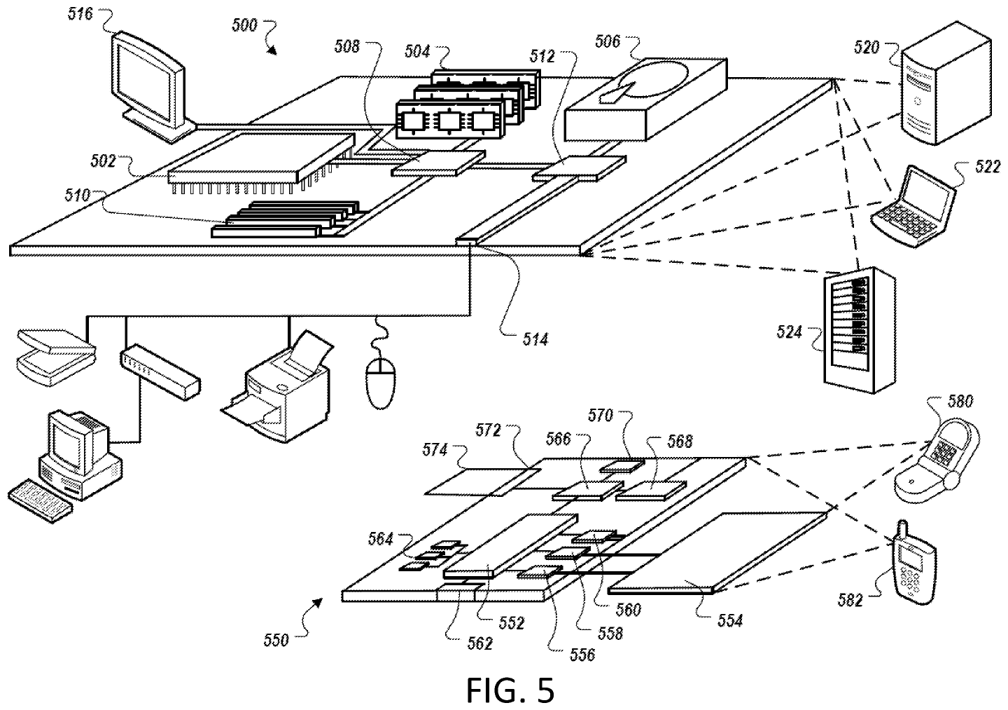

FIG. 5 shows an example of a computer device 500 and a mobile computer device 550 that can be used to implement the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low-speed interface 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high-speed interface 508 manages bandwidth-intensive operations for the computing device 500, while the a low-speed interface 512 manages lower bandwidth-intensive operations. Such allocation of functions is exemplary only. In one implementation, the high-speed interface 508 is coupled to memory 504, display 516 (e.g., through a graphics processor or accelerator), and to high-speed expansion ports 510, which may accept various expansion cards (not shown). In the implementation, a low-speed interface 512 is coupled to storage device 506 and low-speed bus 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router (e.g., through a network adapter).

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MIMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube), LCD (liquid crystal display), or TFT monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The preceding figures and accompanying description illustrate example processes and computer-implementable techniques. However, system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A computing device comprising:
a memory storing instructions;
a communications interface; and
at least one hardware processor interoperably coupled with the memory and the communications interface, wherein the instructions instruct the at least one hardware processor to:
identify, a first user of an institution in response to a trigger based on transactional data of the first user, wherein the first user is identified based on at least one of the transactional data or a first financial instrument associated with an existing account for the first user;
generate, based on the at least one of the transactional data or the first financial instrument, a personalized welcome offer for the first user, the personalized welcome offer comprising an offer to open a new account and a personalized welcome bonus associated with the opening of the new account, wherein a second financial instrument associated with the new account for the user provides different benefits than the first financial instrument;
based on identifying the first user, pre-approve the first user for the personalized welcome offer;
based on a successful pre-approval, provide the personalized welcome offer to a device associated with the first user via the communications interface;
receive acceptance of the personalized welcome offer from the device associated with the first user via the communications interface; and
in response to receiving acceptance of the personalized welcome offer, generate a new data record associated with the new account for the first user and initiate effects of the personalized welcome bonus upon opening the new account.

2. The computing device of claim 1, wherein the instructions further instruct the at least one hardware processor to:
provide information relating to the new account to one or more electronic payment tools installed on the device associated with the first user.

3. The computing device of claim 1, wherein the institution is a financial institution, and wherein the new account is a financial instrument account.

4. The computing device of claim 1, wherein the second financial instrument is a credit card.

5. The computing device of claim 1, wherein the second financial instrument is a mobile payment instrument.

6. The computing device of claim 1, wherein the first user is further selected based on current financial instruments offered by the financial institution, and wherein the transactional data comprises the first user's spending patterns.

7. The computing device of claim 1, wherein the first user is identified as being eligible for a new offer for a new financial instrument.

8. The computing device of claim 1, wherein the instructions further instruct the at least one hardware processor to:
generate the welcome bonus, including select one or more entities, wherein the welcome bonus includes one or more accelerators associated with entities that are anchor tenants of the institution and whose services or products the first user purchases.

9. The computing device of claim 8, wherein selection of entities is based on a determination of the anchor tenants of the institution and an analysis of enterprise data of the first user.

10. The computing device of claim 9, wherein the analysis determines the entities at which the first user makes frequent purchases.

11. The computing device of claim 9, wherein the analysis determines the entities at which the first user has made purchases that exceed a total threshold purchase amount.

12. The computing device of claim 1, wherein the welcome bonus includes one or more elements, including a length of the personalized welcome offer, an accelerator bonus, and a number of entities.

13. The computing device of claim 12, wherein the elements of the welcome bonus are based on an analysis of enterprise data including time of year, spending patterns of the first user, eligible merchants for the offer, demographics of the first user, and data associated with comparable users.

14. The computing device of claim 1, wherein the personalized welcome offer is provided through directed advertising via authorized social media or mail.

15. The computing device of claim 1, wherein the instructions further instruct the at least one hardware processor to:
after a predetermined time has elapsed since opening the new account, provide the device associated with the first user with one or more incentives to use one or more rewards accumulated from the personalized welcome bonus.

16. The computing device of claim 1, wherein the instructions further instruct the at least one hardware processor to:
provide a notification to the device associated with the first user indicating a number of points earned for a particular transaction using the new account.

17. The computing device of claim 1, wherein the instructions further instruct the at least one hardware processor to:
identify a transaction that involves the new account of the first user;
determine that the transaction is associated with an accelerator of the personalized welcome bonus; and
apply the accelerator to the transaction.

18. A non-transitory, computer-readable medium storing computer-readable instructions that, when executed by one or more data processing apparatus, cause the one or more data processing apparatus to perform operations comprising:
identifying, a first user of an institution in response to a trigger based on transactional data of the first user, wherein the first user is identified based on the transactional data;
generating, based on the transactional data, a personalized welcome offer for the first user, the personalized welcome offer comprising an offer to open a new account and a personalized welcome bonus associated with the opening of the new account, wherein the new account is different than existing accounts for the first user;
based on identifying the first user, pre-approving the first user for the personalized welcome offer;
based on a successful pre-approval, providing the personalized welcome offer to a device associated with the first user via the communications interface;
receiving acceptance of the personalized welcome offer from the device associated with the first user; and
in response to receiving acceptance of the personalized welcome offer, generating a new data record associated with the new account for the first user and initiating effects of the personalized welcome bonus upon opening the new account.

19. The non-transitory, computer-readable medium of claim 18, wherein the operations further comprise:
provide information relating to the new account to one or more electronic payment tools installed on the device associated with the first user.

20. A computerized method performed by one or more processors, the method comprising:
identifying, a first user of an institution in response to a trigger based on transactional data of the first user, wherein the first user is identified based on a first financial instrument associated with an existing account for the first user;
generating, based on the first financial instrument, a personalized welcome offer for the first user, the personalized welcome offer comprising an offer to open a new account and a personalized welcome bonus associated with the opening of the new account, wherein a second financial instrument associated with the new account for the first user provides different benefits than the first financial instrument;
based on identifying the first user, pre-approving the first user for the personalized welcome offer;
based on a successful pre-approval, providing the personalized welcome offer to a device associated with the first user;
receiving acceptance of the personalized welcome offer from the device associated with the first user; and
in response to receiving acceptance of the personalized welcome offer, generating a new data record associated with the new account for the first user and initiating effects of the personalized welcome bonus upon opening the new account.

21. The method of claim 1, wherein the transactional data comprises at least one of current transactional data or historical transactional data.
